(19) United States
(12) Patent Application Publication
(10) Pub. No.: US 2005/0269324 A1
(43) Pub. Date: Dec. 8, 2005

(54) Resin box

(76) Inventors: Seiji Terashima, Funabashi-shi (JP); Takeshi Minaba, Ichihara-shi (JP); Kohji Yamatsuta, Otsu-shi (JP); Yoshinori Ohmura, Osaka (JP)

Correspondence Address: BIRCH STEWART KOLASCH & BIRCH, PO BOX 747, FALLS CHURCH, VA, 22040-0747, US

(21) Appl. No.: 11/175,339

(22) Filed: Jul. 7, 2005

Related U.S. Application Data
(63) Continuation of application No. 10/254,857, filed on Sep. 26, 2002.

(30) Foreign Application Priority Data
Sep. 26, 2001 (JP) 2001-294757
Sep. 26, 2001 (JP) 2001-294766
Sep. 26, 2001 (JP) 2001-294775
Sep. 26, 2001 (JP) 2001-294782

(51) Int. Cl. B62K 21/00

(52) U.S. Cl. 220/62.1; 396/155

(57) ABSTRACT

On a folding section of the thermoplastic sheet there is provided one or more thin-walled section, extending in a longitudinal direction of the folding section, whose minimum thickness is not less than 1/10 and not more than ⅔ the thickness of the thermoplastic resin sheet. Thus, it is possible to provide a box in which rebound of the folding section is reduced and an operation efficiency upon setting up the box and putting goods into the box can be improved.

This application is a Continuation of co-pending application Ser. No. 10/254,857 filed on Sep. 26, 2002, and for which priority is claimed under 35 U.S.C. § 120. The entire contents of each of the above-identified applications are hereby incorporated by reference. This application also claims priority of Application No.2001-294757, 2001-294766, 2001-294775 and 2001-294782 filed in Japan on Sep. 26, 2001 under 35 U.S.C. § 119.

### FIELD OF THE INVENTION

The present invention relates to a resin box, and in particular to a recursive resin box to be suitably used for a returnable box.

### BACKGROUND OF THE INVENTION

Conventionally, a resin box, such as a cardboard box, a plastic box, has been used for containers for transporting various products.

However, a cardboard box is made of paper and therefore it is sensitive to water and is hardly recursive. Further, it causes a problem of paper dust, which is likely to get in the products.

To provide a replacement of such a cardboard box, Japanese Unexamined Patent Publication No. 164933/1996 (Tokukaihei 8-164933, published on Jun. 25, 1996) and Japanese Unexamined Patent Publication No. 79940/2000 (Tokukai 2000-79940, published on Mar. 21, 2000) disclose a resin box, which is made of a folded resin sheet.

However, the conventional resin box made of a folded resin sheet causes inefficiency during the fabrication of the box, as it requires some knack to deal with its repulsion force at the folding portion. Also the repulsion force at the cover sections interferes the work to put in the products in the box.

Further, in the conventional resin box made of a folded resin sheet, when the box is sealed by folding flaps (cover sections), the upper flaps for covering over the lower flaps are lifted by the lower flaps beneath because of the compression strength in the thickness direction of the resin sheet. This causes deterioration of the appearance of the box after sealed, and also causes some difficulties when the sealing sections are sealed with tapes or the like.

Further, in the conventional resin box made of a folded resin sheet, the connection section of each side is joined with metal stitches, metal rivets, or resin pins. In this joining method, the resin sheets are joined at portions having a certain area with arbitrary intervals by using pin-shaped components.

However, with this method, the resin box cannot be completely sealed, and may cause some gaps between the joining portions when a plurality of boxes is placed one on another. These gaps between the joining portions allow dust to get in the box.

Further, the conventional resin box made of a folded resin sheet is harder than a cardboard box and therefore causes a difficulty of the folding work.

### SUMMARY OF THE INVENTION

In view of the foregoing problems, the object of the present invention is to provide a resin box showing reduced rebound of a folding section and being capable of improving operation efficiency upon setting up the box and putting goods into the box.

As a result of earnest study performed by the inventors so as to solve the foregoing problems, they found that: as to a resin box constituted of a thermoplastic resin sheet, it is possible to reduce the rebound of the folding section and to improve the operation efficiency upon setting up the box and putting goods into the box by arranging as follows. According to this, they made the present invention.

In order to achieve the foregoing object, the resin box of the present invention is constituted of a thermoplastic resin sheet including a folding section, wherein the folding section includes at least one thin-walled section, extending in a longitudinal direction of the folding section, whose minimum thickness is not less than 1/10 and not more than ⅔ the thickness of the thermoplastic resin sheet.

Further, in order to achieve the foregoing object, the resin box of the present invention is constituted of a thermoplastic resin sheet including a folding section, wherein the folding section includes at least one thin-walled section, extending in a longitudinal direction of the folding section, whose minimum thickness is not less than 1/10 and not more than ⅔ the thickness of the thermoplastic resin sheet.

Note that, it is more preferable to form two or more thin-walled sections in each folding section, and in the case where two or more thin-walled sections are formed in a folded section, the thin-walled sections are formed in parallel to each other.

According to the invention, the folding section of the thermoplastic resin sheet includes a thin-walled section having a thickness of not less than 1/10 and not more than ⅔ the sheet thickness, thereby improving operation efficiency upon setting up the box and putting goods into the box. Further, rebound of the folding section is reduced, thereby effectively preventing exfoliation and breakage of the connection section joined by pasting, etc.

Therefore, it is possible to provide a resin box showing reduced rebound of the folding section and being capable of improving operation efficiency upon setting up the box and putting goods into the box.

Further, when each folding section includes two or more thin-walled sections parallel to each other, it is possible to fold the folding section more easily in comparison to the folding section including one thin-walled section, and to improve an upright property of the box.

Another object of the present invention is to provide a resin box which shows reduced rebound between overlapping folded cover sections so as to improve an appearance of the box, and can be easily taped at the sealing point using a tape, etc., when the folded cover sections are overlapped and sealed.

Further, another object of the present invention is to provide such a resin box that: when folded covers are overlapped with each other and are sealed, appearance of the box is improved by reducing repulsive force between the folding covers, and a sealing portion can be easily sealed with a tape etc.

As a result of earnest study performed by the inventors so as to solve the foregoing problems, they found that: as to the resin box constituted of the thermoplastic resin sheet, by arranging the folded covers of the thermoplastic resin sheet as follows, the folded covers overlapped with each other do not repel each other, and the upper folded cover is not lifted by the lower folded cover, and the appearance of the box is improved, and it is easier to seal the sealing portion with tapes and the like. According to this, they made the present invention.

In order to achieve the foregoing object, the resin box of the present invention is constituted by folding one or more thermoplastic resin sheet, wherein: the thermoplastic resin sheet is constituted of two or more side face sections, adjacent to each other, that are connected via folding sections to cover sections and bottom sections both of which are freely foldable, and each of the folding sections includes two or more thin-walled sections parallel to each other, and in one folding section, there is provided a level difference between the cover sections adjacent to each other, and in another folding section, there is another level difference between the bottom sections adjacent to each other, the level difference being 1 to 1.2 times the thickness of the thermoplastic resin sheet.

According to the invention, the folding sections are provided between the side face sections adjacent to each other and the cover sections so as to have a level difference whose length is 1 to 1.2 times the thickness of the sheet in a depth direction of the box. For this reason, in a case where the cover sections adjacent to each other or the bottom sections adjacent to each other are folded at an angle of 90°, there exists the level difference whose length is 1 to 1.2 times the thickness of the sheet, so that the cover sections or the bottom sections overlap with each other with less strain. As a result, it is possible to prevent the rise of a cover sections or a bottom section caused by another cover section or the bottom section. Further, it is possible to reduce a gap between the overlapped portions, thereby preventing extraneous objects from coming into the box.

Further, there are provided two thin-walled sections parallel to each other on a folding section, it is possible to fold the folding section more easily than the folding section having a single thin-walled section thereon. Thus, it is possible to obtain not only an advantage that an operation efficiency upon setting up the box and putting goods into the box is improved, but also an advantage that the rebound of the folding section is reduced.

Therefore, it is possible to provide such a box that the rebound of the folding section is reduced and the operation efficiency upon setting up the box and putting goods into the box can be improved.

Further, a further object of the present invention is to provided a resin box capable of enduring the repeated using, and capable of reducing a gap between the overlapped portions so as to prevent extraneous objects from coming into the box.

As a result of earnest study performed by the inventors so as to solve the foregoing problems, they found that: a portion to which a connection portion of the side face section is bonded extends from the folding section on the side of the cover section to the folding section on the side of the bottom section, and there is no rift in bonded faces of the connection portion, so that an extraneous object such as a dust does not come into the box through the gap. According to this, they made the present invention.

In order to achieve the foregoing object, the resin box of the present invention is constituted by folding one or more thermoplastic resin sheet, wherein: the thermoplastic resin sheet is constituted of two or more side face sections connected via folding sections, each of which has one or more thin-walled section, to cover sections and bottom sections both of which are freely foldable, and the thermoplastic sheet includes a connection portion connected to an opening side portion of at least one of the side face sections adjacent to each other, and the thermoplastic resin sheet is a monolayer resin sheet constituted of a foamed layer whose expansion ratio is 1.5 to 9, or a multilayer resin sheet constituted of at least a foamed layer whose expansion ratio is 1.5 to 9 and at least a non-foamed layer, and the connection portion is welded to the side face section so that a length of the connection portion is substantially as long as a distance between a folding section along a cover section and a folding section along a bottom section extending from the side face section from which the cover section extends, and a bonded face of the connection portion extends from the folding section along the cover section to the other folding section along the bottom sections.

According to the invention, a connection portion is welded on the side face section so as to have the same length as a distance between a folding section along a cover section and a folding section along a bottom section extending from the side face section from which the cover section extends.

Thus, the bonded face is successively provided from the folding section along the cover section to the folding section along the bottom section. Thus, there is no rift in the bonded face on the connection section. Therefore, there is no possibility that dust comes through a gap into the box. Further, the resin sheet itself is bonded without using other adhesive, so that it is possible to efficiently recycle it.

Meanwhile, the resin sheet is a monolayer resin sheet constituted of a foamed layer whose expansion ratio is 1.5 to 9, or a multilayer resin sheet constituted of at least one foamed layer whose expansion ratio is 1.5 to 9 for each layer and at least one non-foamed layer.

In a case where the resin sheet is the monolayer resin sheet constituted of a foamed layer whose expansion ratio is less than 1.5, or in a case where the resin sheet is the multilayer resin sheet constituted of a non-foamed layer whose expansion ratio is less than 1.5 for all layers, the resin sheet becomes heavy in case of setting up the box. Meanwhile, the monolayer resin sheet constituted of a foamed layer whose expansion ratio is over 9 does not bring about sufficient rigidity.

As a result, it is possible to provide the box that can endure the repetitive usages, and has no gap in the connection section, and can prevent extraneous objects such as dust from coming into the box.

Yet another object of the present invention is to provide a resin box capable of being easily set up and folded with improving folding efficiency.

As a result of earnest study performed by the inventors so as to solve the foregoing problem, they found that: as to the resin box constituted of the thermoplastic resin sheet, the thermoplastic resin sheet is arranged as follows, so that the operation efficiency upon setting up the box and putting goods into the box is improved. According to this, they made the present invention.

In order to achieve the foregoing object, the resin box of the present invention is constituted so as to be a rectangular prism by folding at least one thermoplastic resin sheet, wherein: the at least one thermoplastic resin sheet is constituted of two or more side face sections connected via folding sections, each of which has one or more thin-walled section, to cover sections and bottom sections both of which are freely foldable, and the thermoplastic resin sheet is a monolayer resin sheet constituted of a foamed layer whose expansion ratio is 1.5 to 9, or a multilayer resin sheet constituted of at least one foamed layer whose expansion ratio is 1.5 to 9 and at least one non-foamed layer, and two of the bottom sections adjacent to each other are partially bonded to each other as one pair, and a diagonally folding section is provided in a substantially 45° direction from a corner section on said one pair of the bottom sections that is externally positioned when the bottom sections are folded, and said one pair is opposite to another pair of the bottom sections. Note that, the foamed layer means a layer whose expansion ratio is not less than 1.5, and the non-foamed layer includes not only an absolute non-foamed layer whose expansion ratio is 1, but also a slightly foamed layer whose expansion ratio is not more than 1.5.

According to the invention, the thermoplastic resin sheet is a monolayer resin sheet constituted of a foamed layer whose expansion ratio is 1.5 to 9, or a multilayer resin sheet constituted of at least a foamed layer whose expansion ratio is 1.5 to 9 and at least a non-foamed layer

According to this, at least one layer is constituted of the foamed layer, so that an end face that has been processed is not sharpened. This brings about not only the safety but also a hygienic advantage because an extraneous object does not come into the box through the end face. That is, in a thermoplastic resin sheet provided in a paper cardboard shape, the extraneous object comes into the box through the end face, but in the thermoplastic resin sheet having some thickness due to the foamed layer, the extraneous object is prevented from coming into the box through the end face.

In the present invention, the resin box is arranged so that: the diagonally folding section is provided in a substantially 45° direction from a corner section on said one pair of the bottom sections that is externally positioned when the bottom sections are folded, and said one pair is opposite to another pair of the bottom sections.

According to this, by folding the box along the diagonally folding sections, the box can be easily folded. Reversely, only by opening the folded resin box, the box can be obtained in a three-dimensional shape.

As a result, it is possible to provide the box capable of being easily set up and folded with improving the folding efficiency.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a perspective diagram showing an embodiment of a resin box in the present invention.

FIG. 2 is a development showing the resin box.

FIG. 3(a) is a sectional view showing a shape of a thin-walled section formed in a folding section of the resin box.

FIG. 3(b) is a sectional view showing another shape of the thin-walled section formed in the folding section of the resin box.

FIG. 3(c) is a sectional view showing a further shape of the thin-walled section formed in the folding section of the resin box.

FIG. 4 is a perspective view showing the thin-walled section formed in the folding section of the resin box.

FIG. 5(a) is a sectional view showing a structure of a resin sheet of the resin box, which is a multilayer foamed sheet wherein a foamed layer is sandwiched with non-foamed layers on front and back surfaces.

FIG. 5(b) is a sectional view showing a structure of the resin sheet of the resin box, which is a multilayer foamed sheet wherein the non-foamed layer, a foamed layer with an expansion ratio of 1.5 through 9, and a foamed layer with an expansion ratio of 20 through 40 are sequentially layered from below.

FIG. 5(c) is a sectional view showing a structure of the resin sheet of the resin box, which is a multilayer foamed sheet wherein the non-foamed layer, the foamed layer with an expansion ratio of 1.5 through 9, a foamed layer with a expansion ratio of approximately 30 are sequentially layered from below.

FIG. 5(d) is a sectional view showing a structure of the resin sheet of the resin box, which is a multilayer sheet wherein the foamed layer with an expansion ratio of 1.5 through 9, the non-foamed layer, the non-foamed layer, and the foamed layer with an expansion ratio of 1.5 through 9 are sequentially layered from below.

FIG. 6 is a development of another embodiment of the resin box of the present invention.

FIG. 7 is an end view showing an arrangement of a folding section of the resin box.

FIG. 8(a) is an end view showing another arrangement of the folding section of the resin box.

FIG. 8(b) is an end view showing a further arrangement of the folding section of the resin box.

FIG. 9 shows a side view showing a method of buckling strength evaluation.

FIG. 10 is a perspective view showing chief members of the resin box.

FIG. 11 is a development schematically showing the resin box.

FIG. 12(a) is a development showing one resin sheet of the resin box.

FIG. 12(b) is a development showing the other resin sheet of the resin box.

FIG. 13 is a bottom view showing a back surface of the resin box when set up.

FIG. 14(a) is a sectional view showing a locking section and a locked section on a bottom section of the resin box.

FIG. 14(b) is a sectional view showing another locking section and another locked section on the bottom section of the resin box.

FIG. 15(a) is an exploded perspective view showing a further locking section and a further locked section on the bottom section of the resin box.

FIG. 15(b) is a plan view showing yet another locking section on the bottom section of the resin box.

### DISCLOSURE OF INVENTION

### Embodiment 1

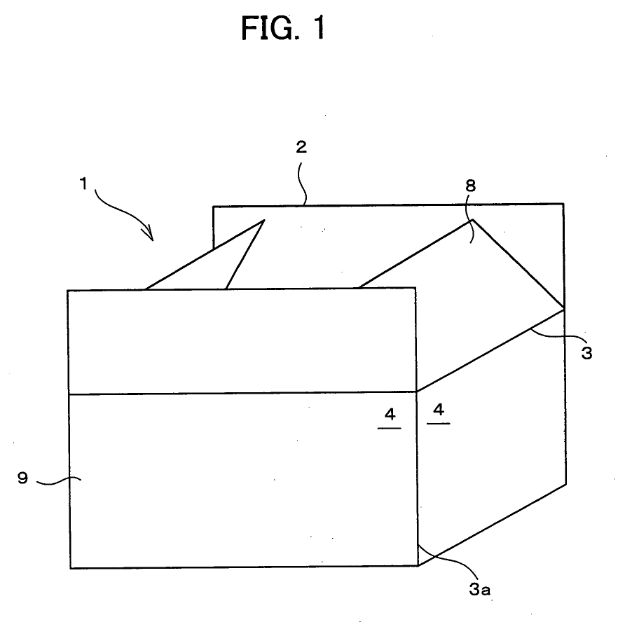

The following will explain an embodiment of the present invention with reference to FIGS. 1 through 5.

A box 1 in the present embodiment is a box capable of being folded, as shown in FIG. 1. The box 1 is constituted of a resin sheet 2 having a thickness of 2 mm through 10 mm. The box 1 may be constituted of a continuous resin sheet 2, or may be composed of not less than two resin sheets 2 which have been joined together using proper means. However, at least one resin sheet 2 constituting the box 1 is provided with at least one folding section 3.

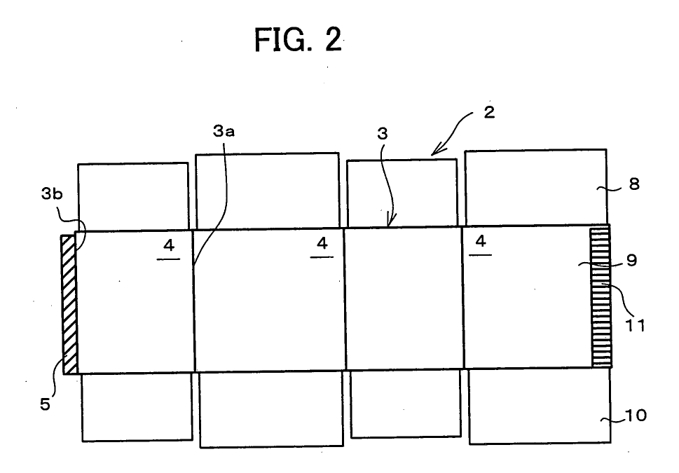

The folding section 3 may be a side section 3a between adjacent two faces 4 which are formed of the continuous resin sheet 2, for example. Alternatively, the folding section 3 may be a folding section 3b provided along a boundary between (1) a face 4 and (2) a connection section 5 (a shaded section in FIG. 2), which is a continuous section of the face 4, for joining the face 4 with another face 4, as shown in FIG. 2.

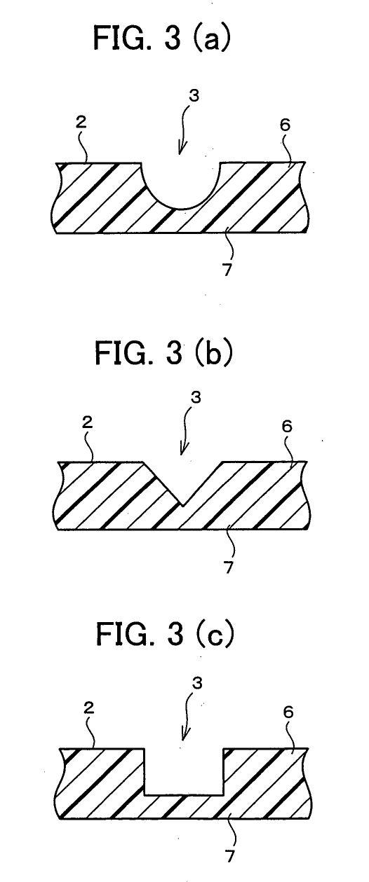

In the box 1, the folding section 3 of the resin sheet 2 has a thin-walled section 7 having a minimum thickness of not less than 1/10 and not more than ⅔ the thickness of a general section 6 of the resin sheet 2, as shown in FIGS. 3(a), 3(b), and 3(c). The thickness of the thin-walled section 7 is more preferably not less than ⅕ and not more than ½ the thickness of the general section 6 of the resin sheet 2. Namely, when the thin-walled section 7 is less than 1/10 the thickness of the general section 6, repetition of folding easily exfoliates and breaks the thin-walled section 7. On the other hand, when the thin-walled section 7 is not less than ⅔ the thickness of the general section 6, the folding section 3 has too much repulsive force as described later. Note that, a groove width of the thin-walled section 7 is preferably not less than ½ the thickness of the general section 6 of the resin sheet 2.

In the box 1 in the present embodiment, since the folding section 3 of the resin sheet 2 is formed with the thin-walled section 7 having the above-described size, the repulsive force (restitutive force) is reduced at the folding section 3 of the resin sheet 2, thereby facilitating set-up of the box 1 as well as packing goods into the box 1. Further, since the repulsive force is reduced at the folding section 3 of the resin sheet 2, the distortion of the box 1 itself is also reduced, thereby effectively preventing the breakage of the box 1 caused by the exfoliation of the connection section, etc.

The thin-walled section 7 in the folding section 3 of the resin sheet 2 may be formed in such a manner that the resin sheet 2 is heated and compressed using proper means, for example. The thin-walled section 7 is preferably formed while stretching the resin sheet 2, for achieving especially high durability to the repetition of folding and tearing. More specifically, the thin-walled section 7 is preferably formed in the following manner. The resin sheet 2 is pressed on with a pressure jig (usually a bar-shaped jig) heated at a temperature which is 5° C. through 40° C. lower than the melting point of the resin, and is then pressured so that the pressured section of the resin sheet 2 has a desirable thickness which is not less than 1/10 and not more than ⅔ the initial thickness. Here, the temperature of the jig preferably ranges from 120° C. through 150° C. when the resin sheet 2 mainly includes polypropylene.

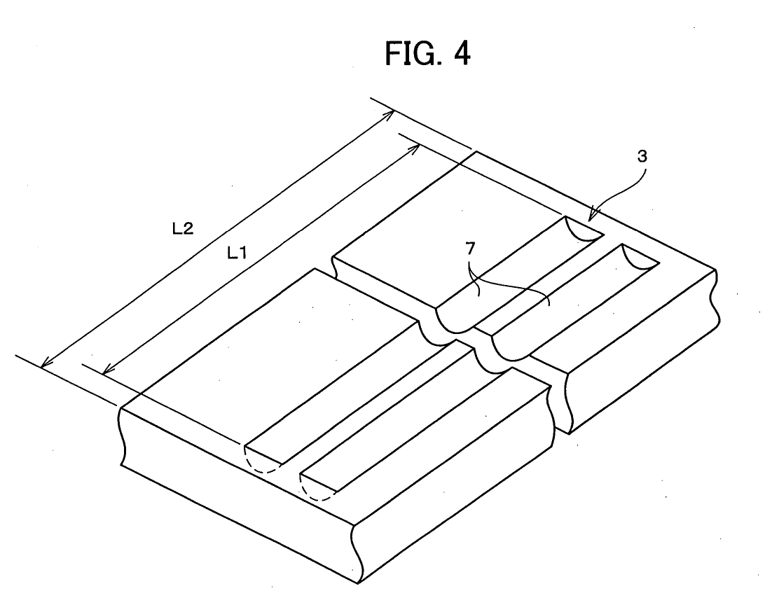

A cross-sectional shape, which is cut in a direction vertical to a longitudinal direction of the thin-walled section 7, in a vicinity of the thin-walled section 7 of the resin sheet 2 is not limited. The cross-sectional shape may be a U-shape as shown in FIG. 3(a), a V-shape as shown in FIG. 3(b), or a rectangular shape having one opening side as shown in FIG. 3(c), but usually the U-shape is preferable because it is possible to effectively prevent stress concentration on the thin-walled section 7. Further, in the box 1 which is formed by bonding one or more resin sheet 2 having the thin-walled section 7, it is preferable that the box 1 is folded so that the thin-walled section 7 is externally positioned, because the box 1 can stand upright more easily. Further, in view of the durability to tearing of the thin-walled section 7, a thin-walled length L1 of the thin-walled section 7 is preferably shorter than a folding length L2 of the folding section 3 formed with the thin-walled section 7, as shown in FIG. 4. Further, one folding section 3 is preferably formed with two or more thin-walled sections 7 which are arranged in parallel to each other. The two or more thin-walled sections 7 arranged in parallel may be internally provided, or may be externally provided as shown in Embodiment 2 as described later.

The box 1 having the above-described arrangement can be manufactured by properly folding the folding section 3 and joining the connection section 5 with one or more resin sheet 2. The resin sheet 2 can be joined in accordance with tacking, screwing, welding, adhesion, but preferably in accordance with the welding or the adhesion. In accordance with the fusion or the adhesion, the resin sheet 2 can be joined through not only a point but also an entire face, thereby achieving high withstand load.

Further, when the resin sheet 2 is joined to the entire face in accordance with the welding or the adhesion, it is possible to prevent an extraneous object from getting into the box 1 through the connection section. This is highly desirable in terms of security and hygiene. Further, it is most desirable to perform the foregoing joint in accordance with the welding because they can be strongly joined with each other. The welding may be performed in accordance with a method in which the resin sheet 2 is subjected to pressure welding by heating the resin sheet 2 after being contacted with a heat plate or brought in a vicinity of a pole of the heat plate. Alternatively, the fusion may be performed in accordance with methods such as ultrasonic welding and vibration welding. The ultrasonic welding is especially desirable, since it is hard to damage a material around the welded section because energy is concentrated in a vicinity of the welded section.

Incidentally, the box 1 desirably has high rigidity and thin sheet thickness. In order to satisfy these demands, the general section 6 of the resin sheet 2 which constitutes the box 1 in the present embodiment preferably has a thickness of not less than 2 mm and not more than 10 mm. When the general section 6 of the resin sheet 2 has a thickness of less than 2 mm, the wall surface of the box 1 has low rigidity, so that the box shape is hard to be retained while stored with the contents or applied with load. On the other hand, when the resin sheet 2 has a thickness of more than 10 mm, the box 1 is too thick in terms of the sheet thickness and is inferior in terms of volume efficiency. The resin sheet 2 more preferably has a thickness of not less than 3 mm and not more than 5 mm.

Further, the above-described resin sheet 2 is constituted of resin made mainly of thermoplastic resin such as propylene resin for example, and is constituted of a monolayer foamed sheet having only a single foamed layer whose expansion ratio is approximately 3, for example, as detailed later. The resin sheet 2 preferably has a density of not less than 0.1 g/cm³ and not more than 0.6 g/cm³. Namely, when the resin sheet 2 has a density of more than 0.6 g/cm³, the resin sheet 2 is too thick in proportion to its rigidity. On the other hand, when the resin sheet 2 has a density of less than 0.1 g/cm³, the resin sheet 2 has low rigidity so that the box shape is hard to be retained and the box 1 lacks shock resistance. Therefore, the resin sheet 2 having the above-described density has high rigidity in proportion to its weight per unit area, and the box 1 composed of the above-described resin sheet 2 has high strength in proportion to its weight.

Further, in terms of the expansion ratio, the resin sheet 2 having only the single foamed layer preferably has an expansion ratio of 1.5 to 9. Namely, when the resin sheet 2 has an expansion ratio of less than 1.5, the resin sheet 2 is of too small weight per unit area in proportion to its rigidity. On the other hand, when the resin sheet 2 has an expansion ratio of more than 9, the resin sheet 2 has low rigidity so that the box shape is hard to be retained and the box 1 lacks shock resistance.

The resin sheet 2 having the low density may be a resin sheet having a hollow structure formed with a rib and a liner, a resin sheet having a honeycomb core hollow structure, a resin sheet having a foamed layer, etc. Among the above-described resin sheets, the resin sheet 2 having the foamed layer is preferable in view of manufacture cost of the resin sheet 2 and tractability of the resin sheet 2 when formed into the box 1.

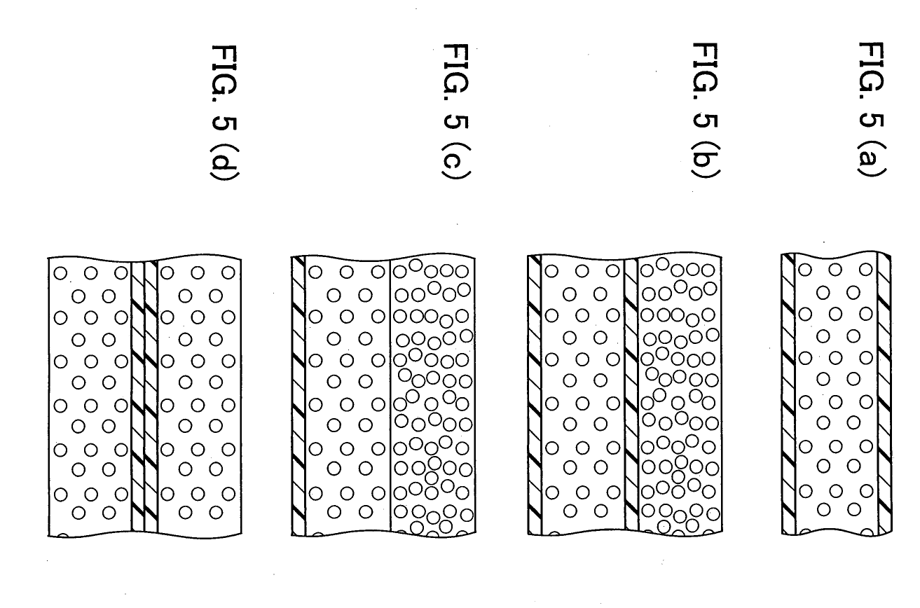

Further, in the present embodiment, the resin sheet 2 may be preferably constituted of the monolayer foamed sheet having only the single foamed layer, as well as a multilayer foamed layer constituted of not less than two foamed layers, or a multilayer foamed layer constituted of at least one foamed layer and at least one non-foamed layer, as shown in FIGS. 5(a) through 5(d). When the multilayer foamed layer is constituted of not less than two foamed layers, materials and expansion ratios of the respective foamed layers may be the same, or may differ from one another.

As the resin sheet 2, the box 1 is preferably constituted of the foamed sheet having both of the foamed layer and the non-foamed layer, because lightness in weight and high strength can be simultaneously achieved. In concrete, it is preferable to use the foamed sheet constituted of the foamed layer whose expansion ratio is 1.5 to 9 and the non-foamed layer, for example, because lightness in weight and high rigidity can be easily achieved. The thickness ratio of the foamed layer and the non-foamed layer can be properly determined so as to achieve desired lightness in weight and desired strength.

Here, in the present embodiment, the foamed layer is a layer whose expansion ratio is not less than 1.5, and is approximately 2 to 40, for example. On the other hand, the non-foamed layer includes a slightly foamed material whose expansion ratio is not more than 1.5, as well as an absolutely non-foamed layer whose expansion ratio is 1.

In concrete, the resin sheet 2 shown in FIG. 5(a), for example, is constituted of (1) a foamed layer having a thickness of 2 mm through 10 mm with an expansion ratio of 1.5 to 9, which is sandwiched in between (2) non-foamed layers respectively having a thickness of 100 μm through 1000 μm with an expansion ratio of less than 1.5 as the front and back surfaces. Note that, in FIG. 5(a), one of the non-foamed layers may be omitted. Further, the resin sheet 2 as shown in FIG. 5(b), for example, is constituted of the non-foamed layer with an expansion ratio of less than 1.5, a foamed layer with an expansion ratio of 1.5 to 9, the non-foamed layer with an expansion ratio of less than 1.5, and a foamed layer with an expansion ratio of 20 through 40, which are sequentially layered from below. Note that, a small circle in FIG. 5(b) indicates a void. Further, as shown in FIG. 5(c), the resin sheet 2 may be constituted of the non-foamed layer with an expansion ratio of less than 1.5, the foamed layer with an expansion ratio of 1.5 to 9, and the foamed layer with an expansion ratio of approximately 30, which are sequentially layered from below. Further, as shown in FIG. 5(d), by using the non-foamed layer with an expansion ratio of less than 1.5 as a core material, the resin sheet 2 may be constituted of the foamed layer with an expansion ratio of 1.5 to 9, the non-foamed layer with an expansion ratio of less than 1.5, the non-foamed layer with an expansion ratio of less than 1.5, the foamed layer with an expansion ratio of 1.5 to 9, which are sequentially layered from below.

The monolayer foamed sheet can be manufactured in accordance with methods such as atmospheric pressure heating, extrusion foaming, pressure foaming, and injection foaming. On the other hand, the multilayer foamed sheet may be manufactured in accordance with methods such as multilayer extrusion foaming, or may be manufactured by layering the respectively manufactured layers in accordance with means such as adhesion and welding.

Further, the material of the resin sheet 2 constituting the box 1 in the present invention is not limited, but preferably resin including mainly propylene resin. This is because the propylene resin (polypropylene in particular) has high performance on integral molding, weldability, heat resistance, water resistance, oil resistance, chemical resistance, etc. The propylene resin may contain ethylene resin, elastomer, etc., as long as the characteristics of the propylene resin are not remarkably undermined.

Further, the resin sheet 2 constituting the box 1 in the present embodiment may contain inorganic fillers such as silica, mica and talc, reinforcing materials such as glass fiber, carbon fiber, aramid fiber and ultra-high molecular weight polyethylene fiber, additives such as heat stabilizers, ultraviolet absorbers and coloring agents, if necessary.

The heat stabilizer may be Sumilizer BP101 (trade name, manufactured by Sumitomo Chemical Co., Ltd.), Ultranox 626 (trade name, manufactured by GE Specialty Chemicals), for example. Further, the ultraviolet absorber may be Sumisorb S577 (trade name, manufactured by Sumitomo Chemical Co., Ltd.), for example.

Further, the box 1 in the present embodiment is required to have fouling resistance when used as a returnable box. Generally, a box made of resin is easily charged, and thus easily fouled by adsorbing dust and the like. Thus, the box 1 is preferably provided with antistatic property. The resin sheet 2 can be provided with the antistatic property using an antistatic agent.

The applicable antistatic agent may be amine compounds such as stearylethanolamine, stearyldiethanolamine, laurylamine and lauryldiethanolamine, amide compounds, ester compounds such as stearyl diethanolmonostearate and glycerin aliphatic ester, quaternary ammonium compounds, pyridine derivatives, and carboxylic derivatives, for example.

The antistatic agent may be a single compound, or may be a mixture of not less than two compounds. Further, the antistatic agent may be not only low molecular weight antistatic agents as described above, but also polymer antistatic agents such as polyether resin and polyamide resin, for example.

Further, among the above-described polymer antistatic agents, it is preferable to use polyether ester amide resin which is expressed in the following general equation;
HO—[OC—R¹—NH]ₓ—(OC—(R²O)_{z}—)_{y}]ₙ—H
(where n, x, y, and z are respectively independent integral numbers, and R¹ and R² are respectively independent alkyl group, cyclic aliphatic group, or aromatic group).

Incidentally, in a case where the box 1 is made dirty, the dirt is wiped out or washed out. The low molecular type antistatic agent mentioned as an example has high affinity with respect to water, so that the antistatic agent is flown with water when the box 1 is washed with water. As a result, the box 1 loses the antistatic property. Then, this problem can be solved by using the polymer type antistatic agent as the antistatic agent.

In order to concretely give the antistatic property to the resin sheet 2, the following processes may be performed: the antistatic agent is kneaded into the resin before forming the resin sheet, or the antistatic agent is applied to the surface of the resin sheet 2, or a film, having the antistatic property, that has been made in advance, is bonded to the surface of the resin sheet 2.

In the case where the antistatic agent is kneaded into the resin, the antistatic agent may be blended in an entire body of the resin sheet 2, but it is preferable that, in the resin sheet 2 constituted of at least two layers, only a layer having a surface on which the antistatic property is required contains the antistatic agent. For example, in a case where the antistatic property is required only on one surface of the resin sheet 2, the resin sheet 2 is constituted of at least two layers, and the antistatic agent is blended only in a layer having a surface on which the antistatic property is required, so that it is possible to efficiently achieve the desired antistatic property. Further, in a case where the antistatic property is required on both surfaces of the resin sheet 2, the antistatic agent is blended in both outermost layers in the resin sheet 2 constituted of at least three layers, so that it is possible to efficiently achieve the desired antistatic property.

It is possible to manufacture the layered sheet having the antistatic property in accordance with an extrusion laminating process. In a case where the polymer type antistatic agent is used to kneading the antistatic agent into the resin, it is preferable that a blending amount of the antistatic agent is not less than 5 weight % with respect to the resin, and it is more preferable that the blending amount of the agent is not less than 10 weight % and not more than 20 weight %. This is because it is difficult to exhibit the sufficient antistatic property at less than 5 weight %.

As described above, according to the box 1 of the present embodiment, it is possible to provide such box 1 that: there occurs little rebound of the folding section 3, and the operation efficiency upon setting up the box 1 and putting goods into the box 1 is improved, and damages caused by internal distortion is hard to occur.

Further, it is possible to preferably use the box 1 of the present embodiment as a returnable box since the box 1 is superior in the durability.

### Embodiment 2

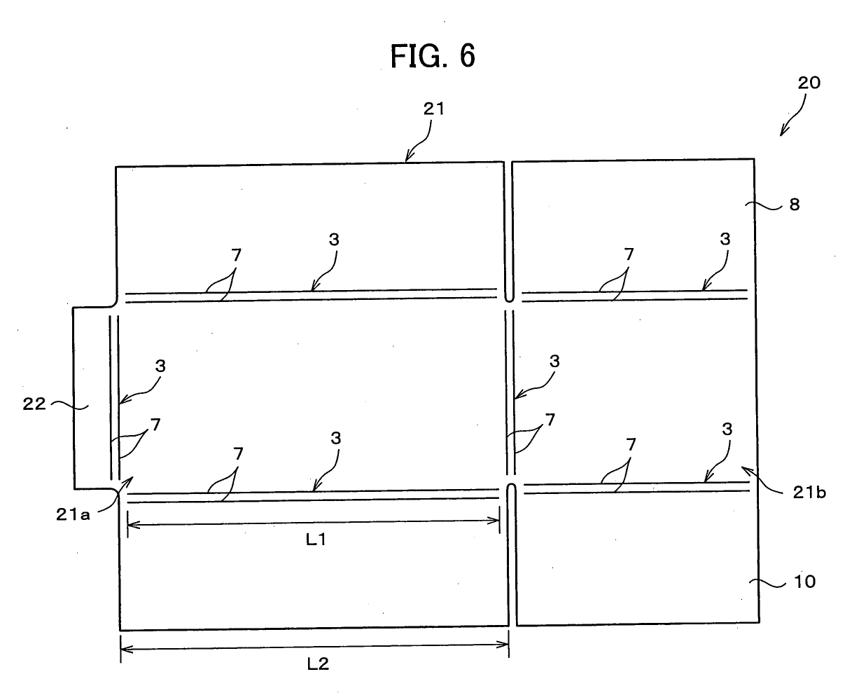

Another embodiment of the present invention is described as follows based on FIG. 6 through FIG. 8. Note that, the same reference signs are given to members having the same functions as the members shown in Embodiment 1 for convenience, and description thereof is omitted. Further, various characteristics described in Embodiment 1 are applicable in combination with characteristics of the present embodiment.

A box 20 of the present embodiment is made by connecting two resin sheets 21, each of which is shown in FIG. 6, to each other. That is, the resin sheet 21 includes: a front/back face constituting member 21a having a cover section 8 and a bottom section 10; a side face constituting member 21b; and a connection section 22. Thus, a single sheet does not constitute four surfaces of a rectangular body as the box 20, so that it is possible to miniaturize a manufacturing device and to simplify a die.

Meanwhile, in the present embodiment, thin-walled sections 7 that are parallel to each other are provided on a single folding section 3, and the folding section 3 is folded so that the thin-walled sections 7 are externally positioned. Further, the two thin-walled sections 7 are such that: a thin-walled length L1 of each thin-walled section 7 is shorter than a folding length L2 of the folding section 3 having the thin-walled portions 7 thereon. Thus, both ends of each thin-walled section 7 of the thin-walled length L1 is not thin-walled. Thus, even in a case where the box 20 is repeatedly folded in use, it is possible to prevent the folding section 3 from being torn off. Note that, although portions that are not thin-walled are provided on both ends of the thin-walled length L1 of each thin-walled section 7 in the present embodiment, it is not necessary to limit the arrangement to this, for example, it is possible to provide one or plural portions that is/are not thin-walled at an arbitrary position of a central portion of each thin-walled section 7.

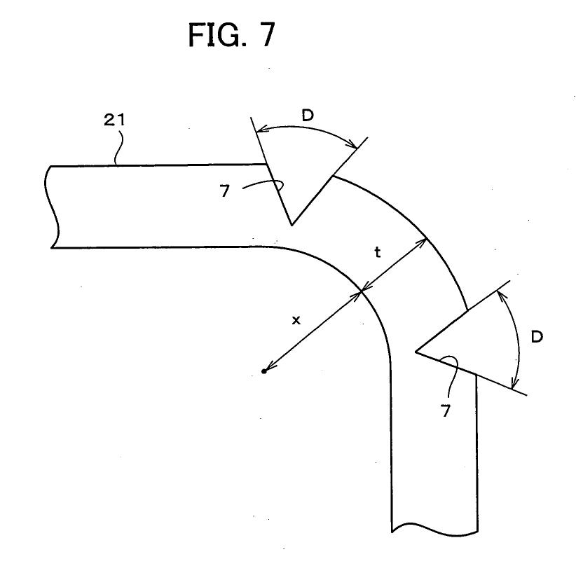

Further, in the present embodiment, as shown in FIG. 7, the two thin-walled sections 7 are such that: supposing that a thickness of the resin sheet 21 is t, 2D that is a sum of external surface opening lengths, that is, a sum of groove widths D, is set so as to satisfy the following expression.
1.4t≦2D≦1.7t (Expression 1)
That is, in order that tugging stress is not exerted on the external surface as much as possible upon folding the folding section 3, it is ideal that a length of the external surface is shorter than a length of internal surface. Here, supposing that a curvature radius of the internal surface is X, a difference Δ between the length of the external surface and the length of the internal surface at the folding section 3 is expressed as follows.

$$\begin{matrix}Δ = 2 Π ( X + t ) / 4 - 2 Π X / 4 \\ = Π t / 2 \\ = 1.57 t\end{matrix}$$

Thus, although it is ideal that the value is set to be 1.5t≦2D, it is found that, as described above, the setting of 1.4t≦2D≦1.7t brings about no problem as to body swelling in a case where the resin sheet 21 having no flexibility is folded. Further, the setting of 2D≦1.7t is based on such reason that: when 2D that is a sum of the groove widths D in the thin-walled sections 7 is too large, the resin sheet 21 tends to be torn at the folding section 3 upon using the box 20 repeatedly. Note that, it is preferable that the thin-walled sections 7 are set to be in a rotation angle π/4 that is the folding section 3.

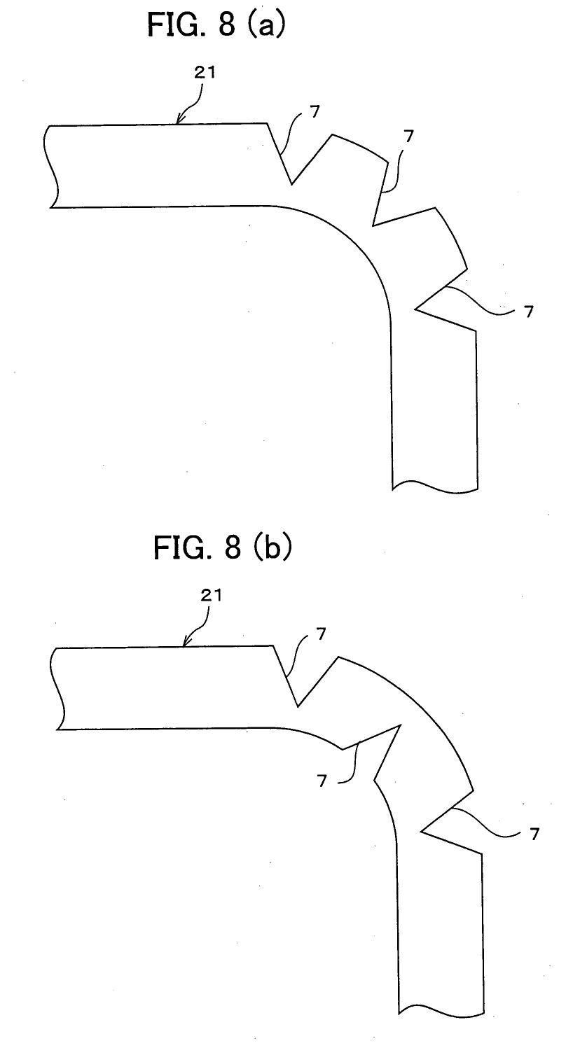

Thus, it is not necessary to limit the number of the thin-walled sections 7 of the folding section 3 to two, for example, it is possible to provide three or more grooves on the external surface as shown in FIG. 8(a). Further, as shown in FIG. 8(b), the foregoing relationship (Expression 1) is satisfied and two thin-walled sections 7 are provided on the external surface, and a single thin-walled section 7 can be provided on the internal surface for example. Thus, it is possible to improve an upright property of the box 20 when the box 20 is set up.

Note that, description of the following arrangements is omitted since they are the same as in Embodiment 1: the arrangements other than the foregoing arrangement, for example, are (a) an arrangement in which each thin-walled section 7 is not less than 1/10 and not more than ⅔ the thickness of the sheet, (b) an arrangement in which the resin sheet 2 is a multi-layered resin sheet including at least a foamed layer whose expansion ratio ranges from 1.5 to 9 for each layer and at least a non-foamed layer, (c) an arrangement in which the resin sheet 2 is constituted of a single-layered resin sheet including at least a foamed layer whose expansion ratio ranges from 1.5 to 9 for each layer or of a multi-layered resin sheet, and at least an outermost layer contains an antistatic agent, and (d) an arrangement in which propylene resin is used as the resin.

As described above, in the box 20 of the present embodiment, there are provided two or more thin-walled sections 7 parallel to each other in a longitudinal direction. Thus, it is possible to fold the folding section 3 more easily than the folding section 3 having a single thin-walled section 7, so that it is possible to improve the upright property of the box 20.

Further, in the box 20 of the present embodiment, the thin-walled sections 7 are externally positioned, so that tugging stress exerted on the external surface of the folding section 3 is reduced. Particularly in a case where there are provided two or more thin-walled sections 7 on the external surface like the present embodiment, the box 20 has more durability with respect to repetition of folding compared with a box having a single thin-walled section 7. That is, if the folding section 3 is repeatedly folded at the single thin-walled section 7, a local portion is greatly damaged, so that the box 20 tends to be broken. However, in a case where two or more thin-walled section 7 are provided on the external surface, the folding section 3 is folded in a curved manner in terms of a cross sectional view, so that the folding section 3 receives less damages compared with the folding section 3 having the single thin-walled section. Thus, it is possible to prevent the damages caused by the repetition of folding, so that it is possible to provide the box 20 that is preferable in using as a returnable box.

Further, in the box 20 of the present embodiment, the two or more thin-walled sections 7 on the folding section 3 are provided so that 2D, the sum of the groove widths of the thin-walled sections 7, is 1.4 to 1.7 times as thick as a thickness of the sheet.

Thus, this value is theoretically a value at which the tugging stress exerted on the external surface of the folding section 3 is reduced, so that the stress exerted on the external surface of the folding section 3 is reduced without fail, and rebound of the folding section 3 is reduced, and the body swelling of the box 20 is reduced. Thus, it is possible to secure the upright property of the box 20.

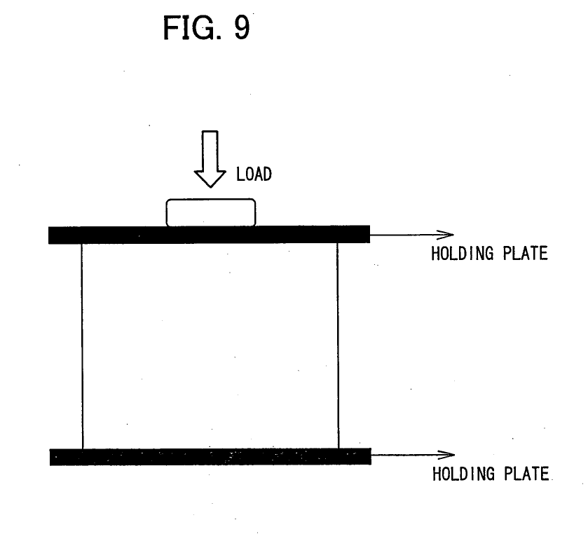

Although the present invention is detailed as follows based on examples, a comparative example, and FIG. 9, the present invention is not limited to them.

### EXAMPLE 1

A foamed polypropylene sheet (Sumiceller (trade name) made by Sumika Plastech Co. Ltd., expansion ratio: 3) having a thickness of 4mm was cut into a shape, shown in FIG. 2, that has been obtained by developing an A type box that is 400 mm in length, 300 mm in width, and 350 mm in height, as schematically shown in FIG. 1. Note that, the A type box is referred in accordance with JIS standard.

Next, a U-shaped stick 5 mm wide that had been heated at 140° C. was pushed against a portion shown by a thick line in FIG. 2 until the minimum thickness of a sheet corresponding to the portion became 1.5 mm, so as to provide the thin-walled section 7 (hinge section) as shown in FIG. 3(a). At this time, the thin-walled section 7 was provided so that non-pressed portions, each of which had an approximately 1 to 3 mm length, remained at both ends of the folding section 3 as shown in FIG. 4. That is, (folding length L2−thin-walled length L1)/2=approximately 1 to 3 mm.

Next, after the connection section 5 of the foamed polypropylene sheet was made to adhere to a plate heated at 250° C. for 1 minute, the connection section 5 was connected to a receiving section 11 (barred portion in FIG. 2) of the same sheet so as to obtain the A type box.

### EXAMPLE 2

A polypropylene film, having a 100 μm thickness, to which 20 weight % of a polyether ester amide resin-based antistatic agent (TPAE 10HP (trade name) made by Fuji Chemical Industry Co., Ltd.) has been added, was bonded, by using a hot melt type adhesive, to each of both surfaces of a foamed polypropylene sheet similar to the foamed polypropylene sheet used in Example 1. By using the obtained layered sheet, the A type box was obtained in the same way as in Example 1.

### COMPARATIVE EXAMPLE 1

An A type box was obtained in the same manner as in Example 1 except that the minimum thickness of the thin-walled section 7 in the sheet was set to 3 mm.

### EXAMPLE 3

A polypropylene film, having a 100 μm thickness, to which 0.5 weight % of a glycerin fatty acid ester antistatic agent (Denon 2220 (trade name) made by Marubishi Oil Chemical Co., Ltd.) has been added, was bonded, by using a hot melt type adhesive, to each of both surfaces of a foamed polypropylene sheet similar to the foamed polypropylene sheet used in Example 1. By using the obtained layered sheet, the A type box was obtained in the same way as in Example 1.

(Evaluation)

The box 1 made in Examples 1 to 3 and Comparative Example 1 was evaluated in accordance with the following method. The result is shown in Table 1.

One of the cover sections 8 of the box 1 was folded by manually pushing it over so that the side face section 9 connected to the cover section 8 has an angle of 90° with respect to the cover section 8. After 30 seconds, the cover section 8 is released from hand. After 30 seconds passed since the cover section 8 had been released from hand, an angle α between the cover section 8 and the side face section 9 was measured. When α was not more than 135°, α was judged to be preferable. When α is not less than 135°, α was judged not to be preferable.

Water resistance of the antistatic agent

A portion of 10 cm×10 cm was cut from the resin sheet. After the portion cut was soaked in water heated at 60° C. for 10 minutes, the portion was air-dried. The operation was performed three times. Surface resistivities of the sheet before and after the soaking process were measured. The surface resistivities were measured under the following conditions.

Testing device: Ultra-super insulation meter SM-8210
Flat plate electrode SME8310 both of which are made by Toa Denpa Kogyo
Kabushiki Kaisha.
Testing environment: 23° C./50% RH
Applied voltage: 500V

Measuring operation: A voltage was applied to the foregoing portion for 10 seconds. After 1 minute passed since the application, a resistivity was measured.

TABLE 1

| | Rebound of | Surface resistance ratio (Ω) | | | |
|---|---|---|---|---|---|
| | folding | Before | | | Three |
| | section | soaking | Once | twice | times |
| Example 1 | Preferable | 10¹⁶ | 10¹⁶ | 10¹⁶ | 10¹⁶ |
| Example 2 | Preferable | 10⁹ | 10⁹ | 10¹⁰ | 10¹⁰ |
| Example 3 | Preferable | 10¹⁰ | 10¹³ | 10¹⁵ | ∞ |
| Comparative | Not | 10¹⁶ | 10¹⁶ | 10¹⁶ | 10¹⁶ |
| Example 1 | preferable | | | | |

### EXAMPLES 4 AND 5

Here, buckling strength evaluation that was performed by using the box 1 of Embodiment 1 and the box 2 of Embodiment 2 is described.

The box 1 internally provided with two thin-walled sections 7 and the box 20 externally provided with two thin-walled sections 7 were evaluated for the degree of the difference therebetween in buckling strength.

Concretely, the box 1 internally provided with two thin-walled sections 7 and the box 20 externally provided with two thin-walled sections 7 were subjected to compression test in which, as shown in FIG. 9, holding plates were brought into contact with the side faces of the boxes and then load was applied downward. In this manner, the box were evaluated for buckling strength.

Each of the boxes 1 and 2 was 325 mm in width×405 mm in depth×295 mm in height. Further, DSS-2000 autograph (trade name)(made by Shimadzu Corporation Ltd.) was used as a compression tester, and compression speed was set to be 10 mm/min. Further, both the resin sheets 2 and 21 had an expansion ratio of three times and a thickness of 4 mm. Further, a U-shaped groove was provided as the thin-walled section 7, and the depth thereof was set to be 1.5 mm. Further, a length of both ends in the folding section 3 except for the thin-walled section 7 was set to be 2 mm. Note that, a temperature at which the stick for providing the thin-walled section 7 was heated was 140° C. upon forming the thin-walled section 7.

Table 2 shows the results of the tests performed in Example 4 in which the box 1 was internally provided with two thin-walled sections 7 and in Example 5 in which the box 20 was externally provided with two thin-walled sections 7.

TABLE 2

| | Example 4 | | Example 5 | |
|---|---|---|---|---|
| | Body | Com- | Body | Com- |
| | swelling | pression | swelling | pression |
| | amount (mm) | load (kg) | amount (mm) | load (kg) |
| Initial stage | 3.5 | 0 | 1.8 | 0 |
| (upon setting | | | | |
| up the box) | | | | |
| Upon flexing | 12.0 | 148 | 2.0 | 53 |
| by 10 mm | | | | |
| Upon flexing | 22.5 | 293 | 15.0 | 183 |
| by 20 mm | | | | |
| Buckling yield | — | 311 | — | 409 |
| point | | | | |

Table 2 shows the following facts.

\mathring{1} According to the conditions of the box 1 and the box 20 at an initial stage (upon setting up the box), the body swelling amount of the box 1 at the initial stage (upon setting up the box) was 3.5 mm. On the other hand, the body swelling amount of the box 20 at the initial stage (upon setting up the box) was 1.8 mm. Thus, a swelling ratio of the box 1 upon setting up the box was as large twice as that of the box 20. That is, this means that the body swelling amount of the box 20 externally provided with two thin-walled sections 7 is small upon setting up the box.

\mathring{2} The body swelling amount of the box 1 when the box flexed by 10 mm was 12.9 mm. On the other hand, the body swelling amount of the box 20 when the box flexed by 10 mm was 2.0 mm. This means that: merely by giving a small transverse load to the box 1, the body swelling amount becomes large. That is, the following result is found: in a case where a load is given from the side to the box, the body swelling amount that is naturally large at the side face vertical to the loading direction becomes larger.

\mathring{3} The compression load at the buckling yield point of the box 1 was 311 kg. On the other hand, the compression load at the buckling yield point of the box 20 was 409 kg. Thus, it is found that the buckling strength of the box 20 was larger than that of the box 1. Further, as to the buckling condition at this time, the box 1 buckled so as to externally swell. On the other hand, the box 20 buckled so as to slightly cave in.

According to the evaluation, it is found that: the box 20 externally provided with two thin-walled sections 7 has a smaller body swelling amount at the initial stage and a larger buckling strength than the box 1 internally provided with two thin-walled sections 7.

### Embodiment 3

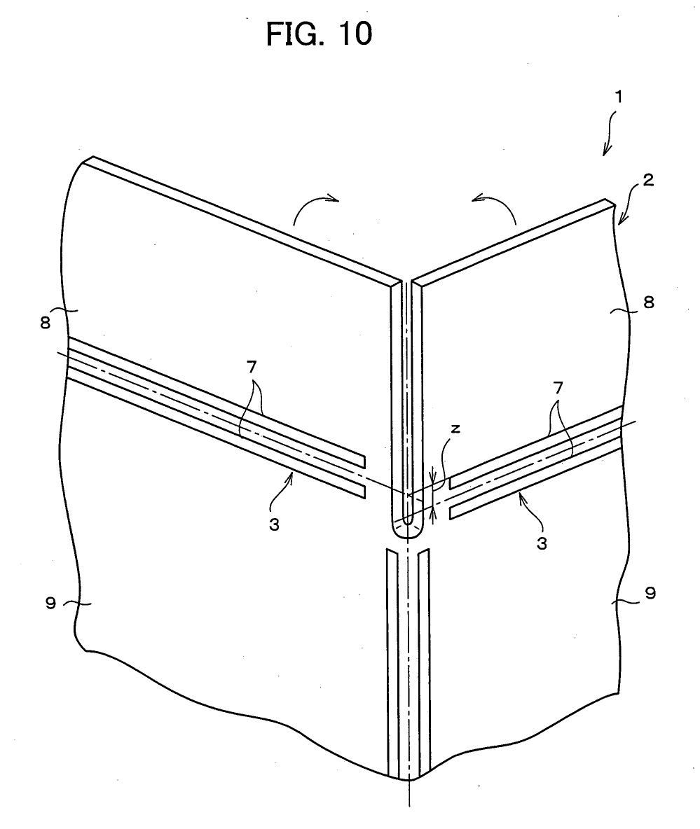

Another embodiment of the present invention is described as follows based on FIG. 10. Note that, the same reference signs are given to members having the same functions as the members described in Embodiments 1 and 2, and description thereof is omitted.

The box 1 of the present embodiment, as shown in FIG. 2, is made by folding the single thermoplastic resin sheet 2 constituted of four side face sections 9 adjacent to each other that are connected via the folding sections 3 to the cover section 8 and the bottom section 9 both of which are freely foldable.

Further, it is possible to provide two thin-walled sections 7 parallel to each other on the folding section 3 as shown in FIG. 10. While, the folding sections 3 are provided respectively on the side face sections 9 adjacent to each other so as to have a level difference Z between the cover sections 8, and the length of the level difference Z is 1 to 1.2 times the thickness of the sheet in a depth direction of the box 1. Note that, although not shown, as to the folding sections 3 connected to the bottom section 10, there is provided the level difference Z whose length is 1 to 1.2 times the thickness of the sheet in the depth direction of the box 1. Further, in the drawing, there is formed the level difference Z whose length is 1 to 1.2 times the thickness of the sheet in the case where the two thin-walled sections 7 parallel to each other are externally provided, but the arrangement is not necessarily limited to this. It is also possible to provide the level difference Z whose length is 1 to 1.2 times the thickness of the sheet in the case where two thin-walled sections 7 parallel to each other are externally provided. Further, it is also possible to provide the level difference Z whose length is 1 to 1.2 times the thickness of the sheet in the case where a single thin-walled section 7 is provided on the folding section 3 regardless of whether the thin-walled section 7 is provided internally or externally.

According to the foregoing arrangement, in a case where the cover sections 8 adjacent to each other or the bottom sections 10 adjacent to each other are folded at an angle of 90°, there exists the level difference Z whose length is 1 to 1.2 times the thickness of the sheet, so that the cover sections 8 or the bottom sections 10 overlap with each other with less strain. As a result, it is possible to prevent the rise of the cover sections 8 or the bottom sections 10 caused by the other cover section 8 or the bottom section 10.

That is, in a case where there is not provided the level difference Z, the one cover section 8 or the one bottom section 10 is raised by the other cover section 8 or the other bottom section 10 at a portion where the cover sections 8 or the bottom sections are overlapped with each other, so that the one cover section 8 or the bottom section 10 rises higher than the case where the level difference Z is provided, but this problem is solved by the level difference Z in the resin sheet 2.

Further, in the resin sheet 2, the level difference Z causes the cover sections 8 or the bottom sections 10 not to be overlapped with each other in a curved manner, so that it is possible to reduce a gap in the overlapping portion. Thus, it is possible to prevent extraneous objects from coming into the box. Note that, as to a conventional cardboard box made of paper, paper is so flexible that the overlapping portions are flexibly united, thus bringing about no gap. Further, the level difference Z is 1 to 1.2 times the thickness of the sheet. That is, when the level difference is too large, the gap becomes large in the overlapping portions. Thus, it is preferable that the level difference is 1 to 1.2 times the thickness of the sheet.

Further, in a case where there are provided the two thin-walled sections 7 parallel to each other on the folding section 3, it is possible to fold the folding section 3 more easily than the folding section 3 having the single thin-walled section 7 thereon.

Thus, it is possible to obtain not only an advantage that an operation efficiency upon setting up the box and putting goods into the box is improved, but also an advantage that the rebound of the folding section 3 is reduced. Thus, it is possible to provide the box 1 in which the rebound of the folding section 3 is reduced and the operation efficiency upon setting up the box and putting goods into the box can be improved.

As described above, the level difference Z is provided in the box 1 of the present embodiment, so that it is possible to provide the box 1 in which the rebound of the folding section 3 is reduced and the operation efficiency upon setting up the box and putting goods into the box is improved, and damages caused by the internal distortion is hard to occur.

Further, it is possible to preferably use the box 1 of the present embodiment as a returnable box since the box 1 is superior in the durability.

Note that, the box 1 of the present embodiment is made by folding the single resin sheet 2 constituted of four side face sections 9 adjacent to each other that are connected via the folding sections 3 to the cover section 8 and the bottom section 9. However, the box 1 is not necessarily limited to this arrangement, but the box 1 may be arranged by providing the side face sections 9 adjacent to each other so as to be connected via the folding section 3 to the cover section 8 and the bottom section that are freely foldable.

Thus, it is possible to make the box 1 by folding four resin sheets 2 containing the side face sections 9 connected via the folding section 3 to the cover section 8 and the bottom section 10. On the other hand, the box 1 may be arranged by joining two resin sheets 21 and 2 to each other like the box 20 described in Embodiment 2.

Further, in the present embodiment, the box 1 is a rectangular, so that the side face section 9 exist in four surfaces, but the box 1 may be provided in a polygonal manner such as a triangle plane shape in which three side face sections 9 exist or a pentagonal plane shape in which five side face sections 9 exist.

Note that, as to other arrangements, it is possible to use the characteristics of Embodiments 1 and 2.

### Embodiment 4

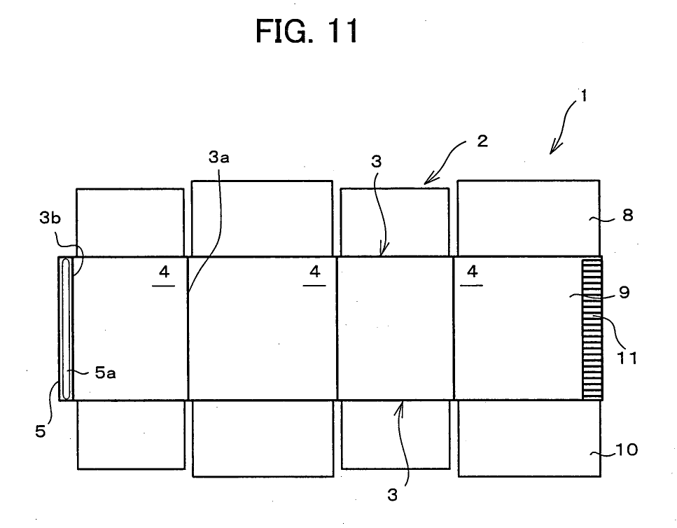

Another embodiment of the present invention is described as follows based on FIG. 11. Note that, the same reference signs are given to members having the same functions as the members shown in figures corresponding to Embodiments 1 to 3, and description thereof is omitted.

In the present embodiment, as shown in FIG. 11, a connection section 5 as a connection portion is laminated on the side face section 9 so as to have the same length as a distance from a connection point of the cover section 8 and the folding section 3 to a connection point of the bottom section 10 and the folding section 3. Concretely, not less than 80% area of the connection section 5 is to be bonded to the side face section 9. Thus, it is possible to provide the box 1 that is strong with respect to exfoliation and compression in a box shape. That is, when a bonding face 5a occupies not less than 80% area of the connection section 5, it is possible to substantially use the entire surface of the connection section 5 as the bonding face 5a.

Further, in the present invention, the bonding face 5a is successively provided from the connection portion of the cover section 8 and the folding section 3 to the connection portion of the bottom section 10. Thus, there is no rift in the bonding face 5a on the connection section 5. Therefore, there is no possibility that dust comes through a gap into the box. Further, the resin sheet 2 itself is bonded without using other adhesive, so that it is possible to efficiently recycle it.

Further, as described above, the resin sheet 2 is the monolayer resin sheet constituted of a foamed layer whose expansion ratio is 1.5 to 9, or the multilayer resin sheet constituted of at least a foamed layer whose expansion ratio is 1.5 to 9 for each layer and at least a single non-foamed layer.

That is, in a case where the resin sheet 2 is the monolayer resin sheet constituted of a foamed layer whose expansion ratio is less than 1.5, or in a case where the resin sheet 2 is the multilayer resin sheet constituted of a non-foamed layer whose expansion ratio is less than 1.5 for all layers, the resin sheet 2 becomes heavy in case of setting up the box. Meanwhile, the monolayer resin sheet constituted of a foamed layer whose expansion ratio is over 9 does not bring about sufficient rigidity.

As a result, it is possible to provide the box 1 than can endure the repetitive usages, and has no gap in the connection section, and can prevent extraneous objects such as dust from coming into the box.

As described above, it is possible to preferably use the box 1 of the present embodiment as a returnable box since the box 1 is superior in the durability.

Note that, as to other arrangements, it is possible to use the characteristics of Embodiments 1 through 3.

### Embodiment 5

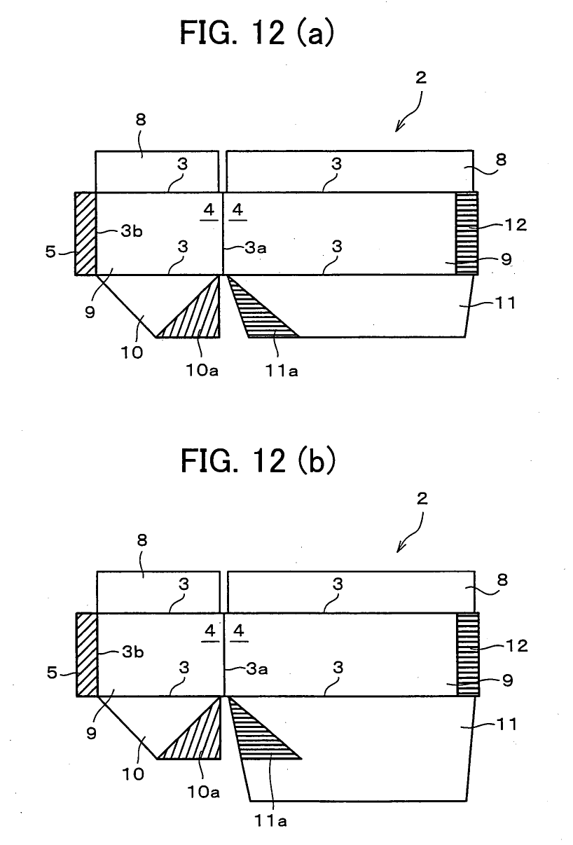

The following will explain another embodiment of the present invention with reference to FIGS. 12 through 15. Note that, for ease of explanation, members having the same functions as those shown in the drawings pertaining to the first through fourth embodiments above will be given the same reference symbols, and explanation thereof will be omitted here.

A box 1 in the present embodiment is a box able to be folded, as shown in FIG. 1. The box 1 is constituted of a resin sheet 2 having a thickness of 2 mm through 10 mm. The box 1 may be constituted of a continuous resin sheet 2, or may be constituted of two or more resin sheets 2 which have been joined together using proper means. However, at least one resin sheet 2 composing the box 1 is provided with at least one folding section 3.

The folding section 3 may be a side section 3a between adjacent two faces 4 which are formed with the continuous resin sheet 2, for example. Alternatively, the folding section 3 may be a folding section 3b provided at a boundary between (1) a face 4 and (2) a connection section 5 (a shaded section in FIG. 2), which is a continuous section of the face 4, for joining the face 4 with connected sections 12 of another face 4, as shown in FIGS. 12(a) and 12(b).

Here, in the present embodiment, as shown in FIGS. 12(a) and 12(b), the box 1 shown in FIG. 1 is completed in such a manner that the thermoplastic resin sheets 2 are joined together and folded so as to be formed into a rectangular parallelepiped shape. The thermoplastic resin sheets 2 are composed of two adjacent side sections 9 in which a freely openable and closable cover section 8 and a bottom section 10, or the cover section 8 and a bottom section 11 are respectively connected via the folding section 3.

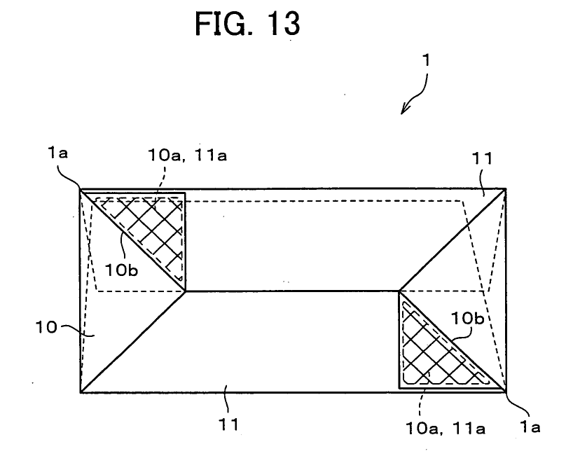

Further, in the box 1 of the present embodiment, as shown in FIGS. 12(a) and 12(b), respective portions of the two adjacent bottom sections 10 and 11 are welded via welding sections 10a and 11a. Further, as also shown in FIG. 13, diagonally folding sections 10b respectively in a substantially 45° direction from corner sections 1a are formed on a pair of bottom sections 10 which are folded to be externally positioned among two pairs of the bottom sections 10 and the bottom sections 11 which respectively face one another.

With this, by folding the box 1 along the diagonally folding sections 10b, the box 1 can be easily folded. Reversely, only by opening the folded box 1, the box 1 can be obtained in a three-dimensional shape.

As a result, it is possible to provide the box 1 capable of being easily set up and folded with improving the folding efficiency.

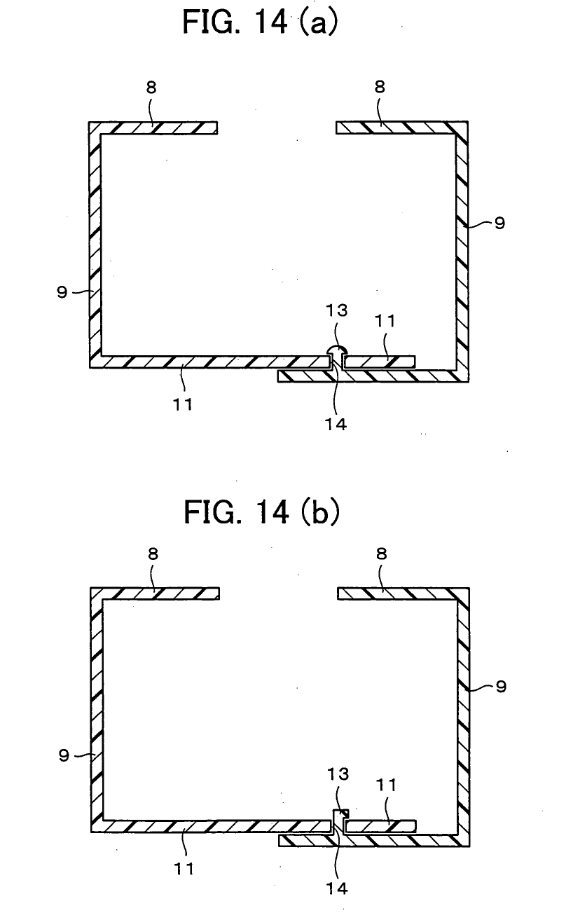

Further, in the box 1 of the present embodiment, among the two pairs of the bottom sections 10 and the bottom sections 11 which respectively face one another, the pair of bottom sections 11 which are folded to be internally positioned are overlapped with each other when folded, as shown in FIG. 14(a).

In other words, when the pair of bottom sections 11 which are folded to be internally positioned, among the two pairs of the bottom sections 10 and the bottom sections 11 which respectively face one another, have the same length in their facing directions, the goods are managed to be put into the box 1 while the box 1 is open. However, when the goods are heavy to some extent, the goods may drop off through a butted section of the both bottom sections 11.

In the present embodiment, however, among the two pairs of the bottom sections 10 and the bottom sections 11 which respectively face one another, the pair of bottom sections 11 which are folded to be internally positioned are overlapped with each other when folded, as described above. Further, one of the bottom sections 11 is longer than the other bottom section 11 in their facing directions.

With this, it is possible to prevent the goods from being dropped off from the bottom, when storing somewhat heavy goods in the box 1.

Note that, the bottom section 11 preferably has the substantially same length as the width length of the box 1. This surely prevents the goods from being dropped off from the bottom.

Further, in the box 1 of the present embodiment, as shown in FIG. 13, among the two pairs of the bottom sections 10 and the bottom sections 11 which respectively face one another, the pair of bottom sections 11 which are folded to be internally folded are provided with (1) a bump-shaped latching section 13 on one of the overlapping bottom sections 11, and (2) a latched section 14 on the other overlapping bottom section 11, being constituted of a hole that allows the bump-shaped latching section 13 to come into the latched section 14, as shown in FIG. 14(a).

This surely prevents the goods from being dropped off from the bottom when storing somewhat heavy goods in the box 1.

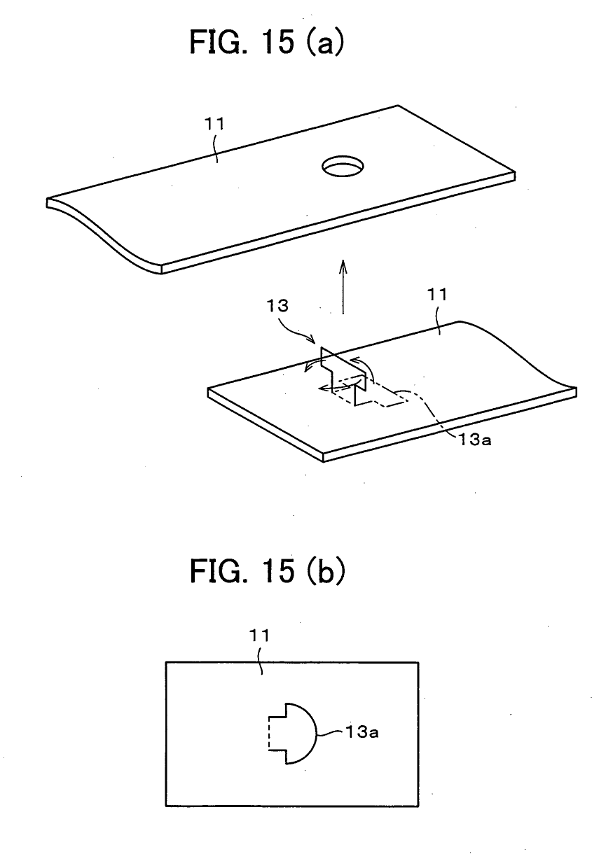

Incidentally, the latching section 13 is not limited to a “fungiform” bump as shown in FIG. 14(a), but may be an L-shaped bump as shown in FIG. 14(b). Further, the latching sections 13 shown in FIGS. 14(a) and 14(b) may be provided by forming a bump on the bottom section 11, or by newly providing a bump with adhesion, etc. Further, as shown in FIG. 15(a), a substantially T-shaped cut 13a is cut on one of the bottom sections 11, and the substantially T-shaped cut 13a is folded at a right angle so as to stand upright. Then, while the T-shaped head section is pressured so as to be bent in an arrow direction in FIG. 15(a), the substantially T-shaped cut 13a is come into the latched section 14 constituted of the hole on the other bottom section 11. The pressure is then released so that the latching section 13 formed with the substantially T-shaped cut 13a is latched with the latched section 14 on the other bottom section 11. With these steps, the latching section 13 can be integrally formed with the resin sheet 2.

Note that, the substantially T-shaped cut 13a having a flat head section is explained above, but the shape of the head section is not limited to this. The head section may have a semicircle shape, as shown in FIG. 15(b).

Further, the respective numbers of the latching section 13 and the latched section 14 are not limited to one, but a plurality of latching sections 13 and a plurality of the latched sections 14 may be provided. If the bump becomes an obstacle, the bump may be provided at the corner section or in a vicinity of the side section.

As described above, it is possible to preferably use the box 1 of the present embodiment as a returnable box since the box 1 is superior in the durability.

Further, according to the box 1 of the present embodiment, it is possible to provide such box 1 that: there occurs little rebound of the folding section 3, and the operation efficiency upon setting up the box 1 and putting goods into the box 1 is improved, and damages caused by internal distortion is hard to occur.

Note that, as to other arrangements, it is possible to use the characteristics of Embodiments 1 through 4.

As described, the resin box of the present invention has the arrangement such that the thin-walled section is made to be shorter than the folding section. Thus, durability in the folding can be improved compared to the case where the thin-walled section is made to be the same length as that of the folding section, thus preventing the folding section from being easily torn and broken.

Further, the thin-walled section is externally provided in the resin box of the present invention. This reduces tensility affecting the external surface of the folding section. Particularly, by forming two or more thin-walled sections on the external surface of the folding section, the durability in the folding can be further improved compared to the case where only one thin-walled section is provided even when the folding is repeated many times. More specifically, repetitive folding with respect to one folding section greatly damages the folding section and may cause breakage of the section; however, when two or more thin-walled sections are formed on the external surface, the damage of the folding section can be reduced for each folding section, as the folding sections are bent rather than folded. As a result, the damage due to the repetitive folding can be prevented, and it becomes possible to provide a resin box can suitably be used as a returnable box.

In the resin box of the present invention, in a case where two or more thin-walled sections are provided on the folding section, a total width of the thin-walled sections is 1.4 to 1.7 times the thickness of the thermoplastic resin sheet.

This value can theoretically reduce the tensility affecting the external surface of the folding section. Thus, it certainly reduces the tensility affecting the external surface of the folding section, and reduces the repulsion force in the folding section, and also reduces body swelling of the resin box, and further, ensures upright property of the resin box.

Further, in the resin box of the present invention, the thermoplastic resin sheet is a monolayer resin sheet constituted of a foamed layer whose expansion ratio is 1.5 to 9, or a multilayer resin sheet constituted of at least a foamed layer whose expansion ratio is 1.5 to 9 and at least a non-foamed layer. Note that, the forming layer refers to a layer whose forming expansion ratio is not less than 1.5. Also, the non-foamed layer includes not only absolutely non-foamed layer having an expansion ratio of 1, but also slightly foamed body having an expansion ratio of less than 1.5.

In the foregoing arrangement, the thermoplastic resin sheet may be a monolayer resin sheet, or may be a multilayer resin sheet. However, in the case of a monolayer resin sheet, its foamed layer preferably has an expansion ratio of 1.5 to 9. Further, in the case of a multilayer resin sheet, its foamed layer preferably includes at least a foamed layer having an expansion ratio of 1.5 to 9, and includes at least a non-foamed layer.

With this arrangement, it is possible to reduce the body swelling of the resin box, and to ensure the upright property of the resin box. Particularly, the multilayer resin sheet including at least a non-foamed layer can further improve the upright property of the resin box, as a non-foamed layer has a higher strength than that of a foamed layer. Further, a multilayer resin sheet can improve lightness in weight and crashproof of the box by stacking a plurality of foamed layers respectively having different expansion ratio. This realizes two compatible effects: lightness in weight and strength of the resin box.

Further, in the resin box of the present invention, an antistatic additive is blended in the monolayer resin sheet or at least an outermost layer of the multilayer resin sheet. Therefore, it reduces adsorption of dust or the like, and can keeps the resin box clean.

Further, in the resin box of the present invention, resin constituting the thermoplastic resin sheet is propylene resin. Therefore, it is possible to provide a resin box ensuring superior performance in weldability, heat-resistance, water-resistance, oil-resistance, chemical resistance and the like.

Further, in the resin box of the present invention, in one folding section, there is provided a level difference between the cover sections adjacent to each other, and in an other folding section, there is another level difference between the bottom sections adjacent to each other, the level difference being 1 to 1.2 times the thickness of the thermoplastic resin sheet.

With these level differences of 1 to 1.2 times the thickness of the thermoplastic resin sheet, the adjacent cover sections and the adjacent bottom sections do not directly clash with each other when they are folded at an angle of 90°. As a result, the cover sections and the bottom sections are not lifted by clashing with each other. Further, the gap in the portions where each cover section and each bottom section overlap can be reduced, thus keeping extraneous objects out of the box.

Further, the folding section having at least two thin-walled sections is easier to fold than that having only one thin-walled section. This ensures efficiencies during the composition of the box and the work for putting the products in the box. Also, it reduces repulsion force in the folding section.

With the foregoing arrangement, it is possible to provide a resin box capable of keeping extraneous objects such as dust out of the box, and ensuring efficiencies during the composition of the box and the work for putting the products in the box, by reducing repulsion force in the folding section.

Further, in the resin box of the present invention, a pair of the bottom sections is internally positioned when the bottom sections are folded, and the bottom sections of the pair are overlapped with each other when the bottom sections are folded.

Namely, when each of the bottom sections of the pair internally positioned when the bottom sections are folded have the same length in each opposing direction, though it is possible to put a product while the box is opened, it may go through the juncture of the bottom sections when the product have some weight.

However, in the present invention, a pair of the bottom sections is internally positioned when the bottom sections are folded, and the bottom sections of the pair are overlapped with each other when the bottom sections are folded. Thus, it is possible to prevent the product having some weight from being gone through the juncture of the bottom sections.

Further, in the resin box of the present invention, there is provided a latching section in a protruding manner on one of the bottom sections overlapped with each other, and on an other bottom section, there is provided a latched section constituted of a hole that allows the latching section to come into the latched section.

Thus, it is possible to surely prevent the product having some weight from being gone through the juncture of the bottom sections.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. A resin box constituted of a thermoplastic resin sheet including a folding section, wherein:
the folding section includes at least one thin-walled section, extending in a longitudinal direction of the folding section, whose minimum thickness is not less than 1/10 and not more than ⅔ the thickness of the thermoplastic resin sheet.

2. A resin box constituted by folding at least one thermoplastic resin sheet, wherein:
the thermoplastic resin sheet is constituted of two or more side face sections, adjacent to each other, that are connected via folding sections to cover sections and bottom sections both of which are freely foldable, and
each of the folding sections includes two or more thin-walled sections parallel to each other, and
in one folding section, there is provided a level difference between the cover sections adjacent to each other, and in an other folding section, there is another level difference between the bottom sections adjacent to each other, the level difference being 1 to 1.2 times the thickness of the thermoplastic resin sheet.

3. A resin box constituted by folding at least one thermoplastic resin sheet, wherein:
the thermoplastic resin sheet is constituted of two or more side face sections connected via folding sections, and said side face sections are connected to cover sections and bottom sections via folding sections, and the thermoplastic sheet includes a connection portion connected to an opening side portion of at least one of the side face sections adjacent to each other,
wherein at least one of the folding sections has two or more thin-walled sections,
said cover sections and bottoms sections are freely foldable,
the thermoplastic resin sheet is a monolayer resin sheet constituted of a foamed layer whose expansion ratio is 1.5 to 9, or a multilayer resin sheet constituted of at least one foamed layer whose expansion ratio is 1.5 to 9 and at least one non-foamed layer, and
the connection portion is bonded to one of the said side sections so that a length of the connection portion is substantially as long as a distance between a folding section along a cover section and a folding section along a bottom section extending from the side face section from which the cover section extends, and a bonding face of the connection portion extends from said one folding section on the side of the cover section to said other folding section on the side of the bottom section.

4. The resin box as set forth in claim 3, wherein in one folding section, there is provided one level difference between cover sections adjacent to each other, and in an other folding section, there is provided an other level difference between the bottom sections adjacent to each other.

5. A resin box constituted so as to be a rectangular prism by folding at least one thermoplastic resin sheet, wherein:
the thermoplastic resin sheet is constituted of two or more side face sections connected via folding sections, and said side face sections are connected to cover sections and bottom sections via folding sections,
wherein at least one of the folding sections has two or more thin-walled sections,
said cover sections and bottoms sections are freely foldable,
the thermoplastic resin sheet is a monolayer resin sheet constituted of a foamed layer whose expansion ratio is 1.5 to 9, or a multilayer resin sheet constituted of at least one foamed layer whose expansion ratio is 1.5 to 9 and at least one non-foamed layer, and
two of the bottom sections adjacent to each other are partially bonded to each other as one pair, and a diagonally folding section is provided in a substantially 45° direction from a corner section on said one pair of the bottom sections that is externally positioned when the bottom sections are folded, said one pair being opposite to another pair of the bottom sections.

6. The resin box as set forth in claim 5, wherein said another pair of the bottom sections is internally positioned when the bottom sections are folded, and the bottom sections of said another pair are overlapped with each other when the bottom sections are folded.

7. The resin box as set forth in claim 6, wherein there is provided a latching section in a protruding manner on one of the bottom sections overlapped with each other, and on an other bottom section, there is provided a latched section constituted of a hole that allows the latching section to come into the latched section.

8. The resin box as set forth in claim 1, wherein the thin-walled section is shorter than the folding section.

9. The resin box as set forth in claim 2, wherein each of the thin-walled sections is shorter than each of the folding sections.

10. The resin box as set forth in claim 3, wherein the thin-walled section is shorter than each of the folding sections.

11. The resin box as set forth in claim 1, wherein the thin-walled section is externally provided.

12. The resin box as set forth in claim 2, wherein each of the thin-walled sections is externally provided.

13. The resin box as set forth in claim 3, wherein the thin-walled section is externally provided.

14. The resin box as set forth in claim 1, wherein in a case where two or more thin-walled sections are provided on the folding section, a total width of the thin-walled sections is 1.4 to 1.7 times the thickness of the thermoplastic resin sheet.

15. The resin box as set forth in claim 2, wherein the two or more thin-walled sections are provided on the folding section so that a total width of the thin-walled sections is 1.4 to 1.7 times the thickness of the thermoplastic resin sheet.

16. The resin box as set forth in claim 3, wherein in a case where two or more thin-walled sections are provided on the folding section, a total width of the thin-walled sections is 1.4 to 1.7 times the thickness of the thermoplastic resin sheet.

17. The resin box as set forth in claim 1, wherein the thermoplastic resin sheet is a monolayer resin sheet constituted of a foamed layer whose expansion ratio is 1.5 to 9, or a multilayer resin sheet constituted of at least a foamed layer whose expansion ratio is 1.5 to 9 and at least one non-foamed layer.

18. The resin box as set forth in claim 17, wherein an antistatic agent is blended in the monolayer resin sheet or at least one outermost layer of the multilayer resin sheet.

19. The resin box as set forth in claim 1, wherein resin constituting the thermoplastic resin sheet is propylene resin.

20. The resin box as set forth in claim 2, wherein resin constituting the thermoplastic resin sheet is propylene resin.

21. The resin box as set forth in claim 3, wherein resin constituting the thermoplastic resin sheet is propylene resin.

22. The resin box as set forth in claim 5, wherein resin constituting the thermoplastic resin sheet is propylene resin.
